(19) United States
(12) Patent Application Publication
(10) Pub. No.: US 2005/0077107 A1
(43) Pub. Date: Apr. 14, 2005

(54) Scaffold system with telescoping access ladder and resiliently hinged scaffold access hatch deck

(76) Inventors: Scott D. Libert, Greenfield, WI (US); Robert P. Wiegers, Fox Point, WI (US); Roger S. Frank, New Berlin, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/953,507

(22) Filed: Sep. 29, 2004

Related U.S. Application Data
(60) Provisional application No. 60/507,078, filed on Sep. 29, 2003.

(51) Int. Cl. E04C 1/00; E06C 9/00

(52) U.S. Cl. 182/119; 182/222; 182/77

(57) ABSTRACT

Disclosed herein is a scaffold system having a first deck structure having a first deck structure frame, a deck connected to the frame and including a deck hatch. The system also includes a second deck structure having a second deck structure frame and a deck connected to the frame, the second deck structure positioned at a distance from, and connectable to, the first deck structure. The system further includes a telescoping ladder positioned between the first and second deck structures and connectable to at least one of the first and the second deck structures, the telescoping ladder extendable to a length that corresponds to the distance between the first and the second deck structures. Also disclosed is a resilient deck hatch hinge. Advantageously, a user can ascend the scaffold system from one deck structure to the next while remaining inside the scaffold footprint, promoting safety. The telescoping ladder promotes greater efficiencies from the scaffold supply standpoint.

### CROSS REFERENCE TO RELATED APPLICATION

This application claims the benefit under 35 USC §119(e) of U.S. Provisional Application No. 60/507,078 filed Sep. 29, 2003, which is incorporated herein by reference.

### FIELD AND BACKGROUND OF THE INVENTION

The present invention relates generally to scaffolding and scaffold systems. In one aspect, the invention relates to a scaffold system having resiliently hinged deck hatch, and a telescoping ladder assembly.

In order to elevate and improve accessibility to a project work area, scaffold systems are frequently used. Elevating the work area, however, presents problems for those who are required to work on that elevated surface. Typically, tens, hundreds or even thousands of the scaffold structures are used in the building or other industries in order to, for example, erect or repair construction projects. With this in mind, scaffold workers/users must climb to the elevated surface, and such workers usually either climb a ladder placed exterior to the scaffold structure(s), or, for frame scaffolding, climb the exterior of a scaffold section, using the horizontal support members of a scaffold section as ladder rungs. This is not in any way recommended and it can be very dangerous, since to access the working surface (i.e., deck) of a scaffold section, a worker must often: 1) climb around the walking surface and thus is positioned in a location extended outward from a scaffold deck structure section; and/or 2) a worker must climb through a system of, chains, or horizontal tubes placed above the walking surface to prevent workers from falling off that surface.

Scaffold structures are frequently required to erect/repair structures having straight surfaces. Still, scaffolding is often used in environments in which the ultimate structure to be built or repaired is curved or contoured. The above-mentioned issues of worker safety (i.e., workers climbing scaffolding outside of the scaffolding structure) exist.

Of great significance to the efficiency and repeated use of scaffolding equipment is its sizing. Typically the distance between the deck structures of scaffolding systems is pre-set based on the type of scaffolding used (e.g., system or frame scaffolding). However, since project sizes and uses vary (e.g., a single-story building as opposed to a much larger, multi-level structure), the desired distance between the deck structures might vary from project to project (or even within a single job itself).

Thus, it would be desirable to provide a more safe, efficient and variable scaffolding system to address the aforementioned issues in the scaffolding industry.

### BRIEF SUMMARY OF THE INVENTION

The present invention generally provides a scaffold assembly that overcomes the aforementioned problems and deficiencies.

Disclosed herein is a scaffold system having a first deck structure having first deck structure frame, a deck connected to the frame and including a deck hatch. The system also includes a second deck structure having a second deck structure frame and a deck connected to the frame, the second deck structure positioned at a distance from, and connectable to, the first deck structure. They system further includes a telescoping ladder positioned between the first and second deck structures and connectable to at least one of the first and the second deck structures, the telescoping ladder extendable to a length that corresponds to the distance between the first and the second deck structures. Also disclosed is a resilient deck hatch hinge.

Advantageously, a user can ascend the scaffold system from one deck structure to the next while remaining inside the scaffold footprint, promoting safety. The telescoping ladder promotes greater efficiencies from the scaffold supply standpoint.

Various other features, objects and advantages of the present invention will be made apparent from the following detailed description and the drawings.

### BRIEF DESCRIPTION OF THE DRAWINGS

Preferred embodiments of the invention are described below with reference to the following drawings, which are provided for illustrative purposes only. The drawings illustrate a best mode presently contemplated for carrying out the invention.

In the drawings:

FIG. 1 is a perspective view of an inventive scaffold system according to one aspect of the present invention;

FIG. 2 is a bottom perspective view of a section of the inventive scaffold system showing a deck structure with a deck hatch in a closed position and a ladder in a retracted position such that it is retracted and fastened to the deck structure;

FIG. 3 is an enlarged detailed view of a ladder latching device that is taken along line 3-3 of FIG. 2;

FIG. 4 is an enlarged detailed view of a ladder mounting assembly taken along line 4-4 of FIG. 2;

FIG. 5 is a side sectional view of the scaffold system taken along line 5-5 of FIG. 1 showing a telescoping ladder fully extended so that its length corresponds to a first distance between two deck structures;

FIG. 5a is a side cross-sectional view of the scaffold system similar to that of FIG. 5 showing the telescoping ladder partially extended so that its length corresponds to a second distance between the two deck structures;

FIG. 6 is an enlarged, cross-sectional view of the telescoping ladder and deck structure taken along line 6-6 of FIG. 2 with the ladder in a retracted position;

FIG. 7 is a bottom view of the scaffold system taken along line 7-7 of FIG. 5 showing the telescoping ladder extended and the deck hatch opened;

FIG. 8 is a bottom view of the scaffold system taken along line 8-8 of FIG. 6 showing the telescoping ladder retracted and the deck hatch closed;

FIG. 9 is an enlarged view of the latching mechanism taken along line 9-9 of FIG. 5;

FIG. 10 is a side sectional view of the retracted telescoping ladder taken along line 10-10 of FIG. 6;

FIG. 11 is a cross-sectional view taken along line 11-11 of FIG. 5 showing the deck hatch, secured to the deck structure of the scaffold system, in an open position; and

FIG. 12 is a cross-sectional view taken along line 12-12 of FIG. 6 showing the deck hatch, secured to the deck structure of the scaffold system, in a closed position.

### DETAILED DESCRIPTION OF THE INVENTION

In the following detailed description, references are made to the accompanying drawings which form a part of this application, and in which is shown by way of illustration specific embodiments in which the invention can be practiced. These embodiments are described in sufficient detail to enable those skilled in the art to practice the invention, and it is to be understood that other embodiments can be utilized and that various changes can be made without departing from the spirit and scope of the present invention. Moreover, in the detailed description, like numerals are employed to designate like parts throughout the same. Various items of equipment, such as fasteners, fittings, etc., in addition to various other elements and specific principles of their operation, are omitted to simplify the description. However, those skilled in the art will realize that such conventional equipment and principles of operation can be employed as desired.

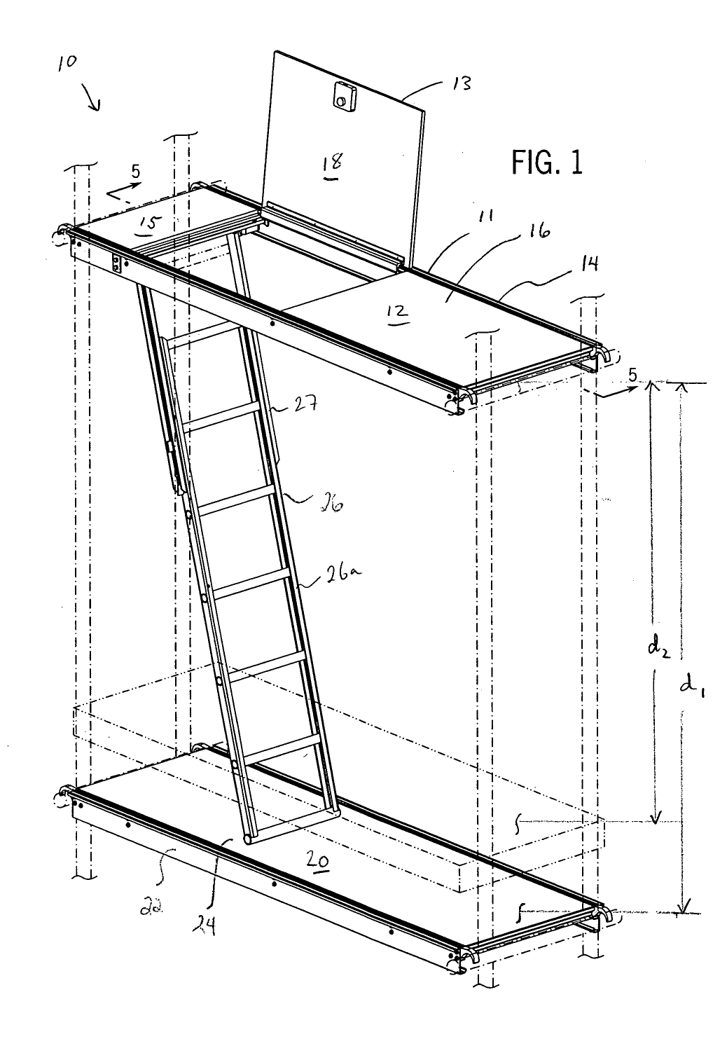

FIG. 1 is a perspective view of an inventive scaffold system 10 according to one aspect of the present invention. The scaffold system 10 comprises a first deck structure 12 having first deck structure frame 14 and a deck 16 connected to the frame and including a deck hatch 18. The system 10 further comprises a second deck structure 20 having a second deck structure frame 22 and a second deck structure deck 24 connected to the frame. When in use, significantly, the second deck structure 20 is positioned at a distance d₁ (also called an “installed height”) from the first deck structure 10. In one embodiment, d, can correspond to a distance of 81 inches. The first and second deck structures are typically connectable to one another, for example via connecting rods and posts (which are shown in phantom). The system 10 further includes a telescoping ladder 26 that is positioned, so as to extend, between the first and second decking structures 12 and 20. The ladder 26, as shown, is interior to and in sliding engagement with slide member 27. The ladder is typically connectable to at least one of the first and the second deck structures (as shown decking structure 12). An alternative position for decking structure 20 is shown in phantom, and in this position the decking structure is positioned at a distance d₂ which is less than d₁ from decking structure 12. In one embodiment, d₁ can correspond to a distance of 73 inches. Advantageously, the telescoping ladder 26 is extendable to a length that corresponds to the desired distance, whether d₁ or d₂, between the first and the second deck structures.

According to another aspect of the invention, scaffold deck structure 12 comprises: a deck 16 having a deck edge 11, the deck having a hatch 18 defined at least in part by an hatch portion edge 13 and a landing portion 15 located at least in part between the deck portion edge and the hatch portion edge. Significantly, the landing portion 15 provides a rigid connecting body for connecting the scaffolding structure 12 to another scaffolding structure.

Still referring to FIG. 1, the scaffold system 10 further comprises a resilient scaffold hatch deck hinge 28. The hinge is connected to the first deck structure frame 14 and to the deck hatch 18 to permit the deck hatch to rotate between an open position (shown) and a closed position (not shown). The hinge and various aspects of its structure and design will be described in greater detail below.

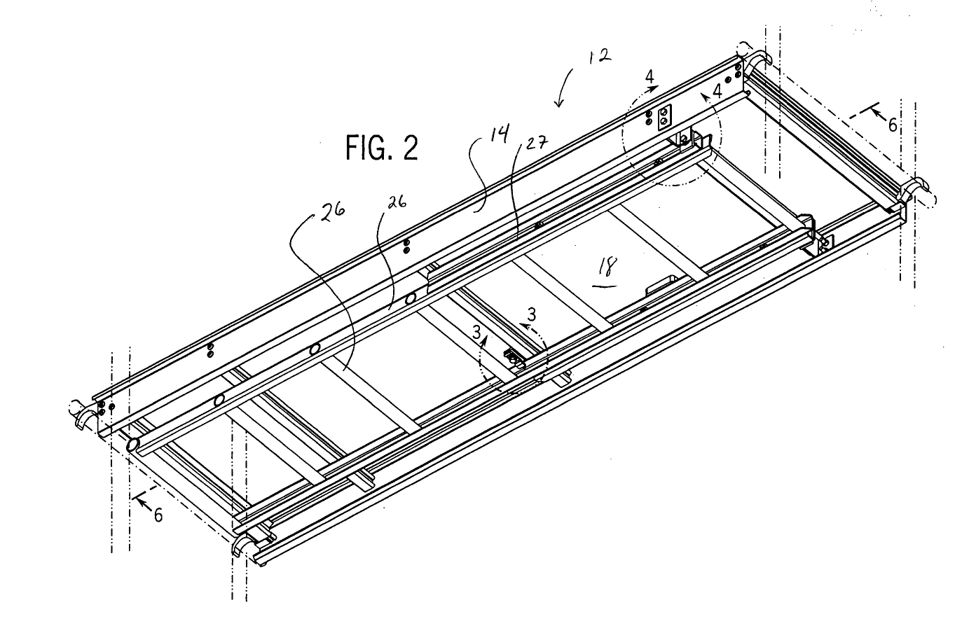

FIG. 2 is a reverse bottom perspective view of deck structure 10, in this case with the deck hatch 18 in a closed position and the telescoping access ladder 26 in a retracted position such that it is retracted and fastened or secured to the deck structure. The ladder 26 is in sliding engagement with slide rail 27. In its retracted position, the ladder is located within the perimeter of first deck structure frame 14, so as not to interfere with a scaffold worker working on a deck structure below, or during transport of the structure.

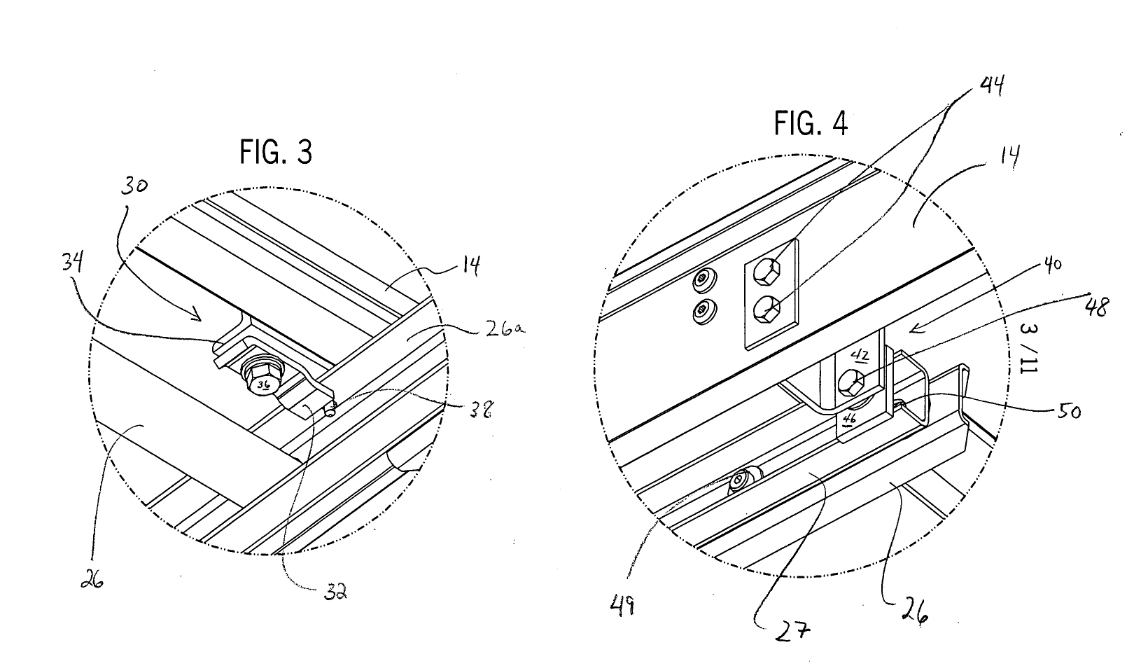

FIG. 3 is an enlarged detailed view of a ladder latching device 30 that is taken along line 3-3 of FIG. 2. The device 30 includes a restraint mechanism 32, which is connected to the frame 14 via an extension portion 34 and rotates about a nut and bolt arrangement 36. The sliding mechanism 32 rotatably cooperates with a latch mechanism 38, in this case a positive lock pin-type latch mechanism, to secure telescoping ladder 26 into (or to release from) its retracted position. Specifically, as shown, the restraint mechanism 32 engages slide rail 27. The latching mechanism is accessible from above the deck structure by a scaffold worker when the hatch deck is open. Advantageously, the ladder latching device does not require a hole to be cut in the hatch deck to release the ladder from its retracted to its extended position.

Stated another way, disclosed in FIG. 3 is a telescoping scaffolding access ladder latch. The ladder latch includes a sliding mechanism having an aperture therethrough; and a bolt passing through the aperture. The bolt serves to connect the sliding mechanism to a scaffolding structure, and further, it permits the sliding mechanism rotatably engage, or disengage, a telescoping access ladder into, or from, a position in which it is secured to the scaffolding structure.

FIG. 4 is an enlarged detailed view of a ladder mounting assembly 40 taken along line 4-4 of FIG. 2. The mounting assembly includes a ladder mount and pivot bracket 42 which is secured to deck frame 14 via bolts 44. The ladder mount and pivot bracket 42 is connected to attachment plate 46 via bolt 48, the attachment plate is connected to slide mechanism 27, and the slide mechanism is connected to the telescoping ladder 26 via bolt 49 engaging slot(s) 50 in a manner that permits the ladder to slide. The ladder mounting assembly 40 permits the ladder 26 to be securably stowed away when the ladder is retracted (FIGS. 2-4). Moreover, the assembly 40 enables the telescoping ladder 26 to be easily rocked into its extended or “in-use” position by rotating the ladder 26 and slide member 27 about the ladder mount and pivot bracket 42 (via bolt 48) and then sliding, so as to extend, the ladder 26 with respect to the slide member 27 until the desired length (corresponding to the distance between consecutively stacked deck structures) is attained. It shall be understood that the connection means (e.g., bolts) can vary to convenience so as to achieve the desired result.

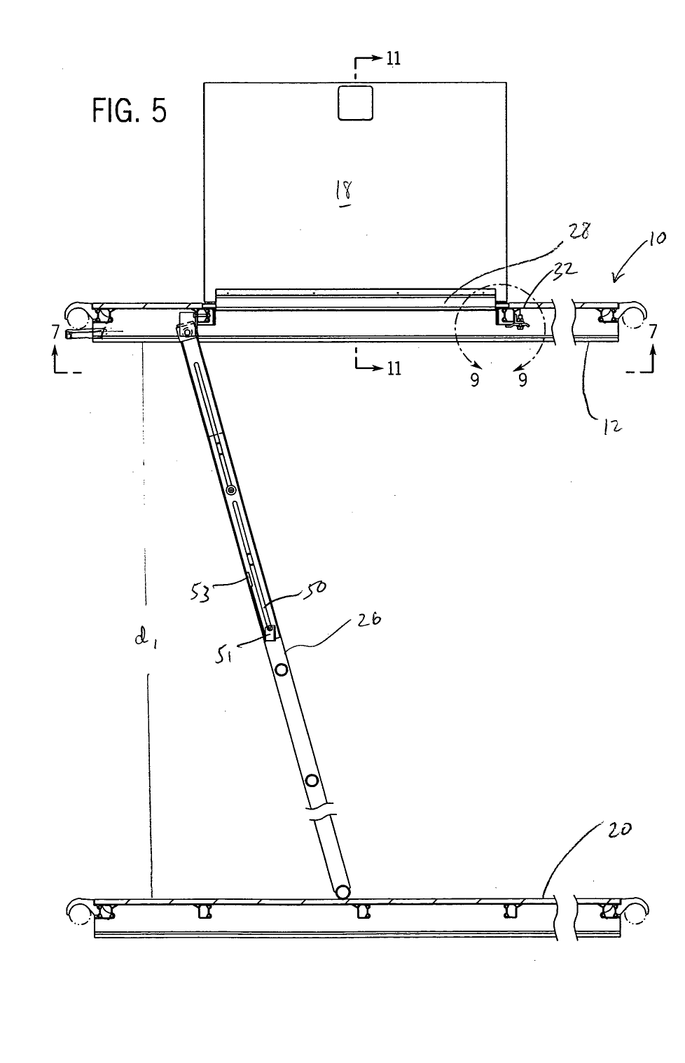

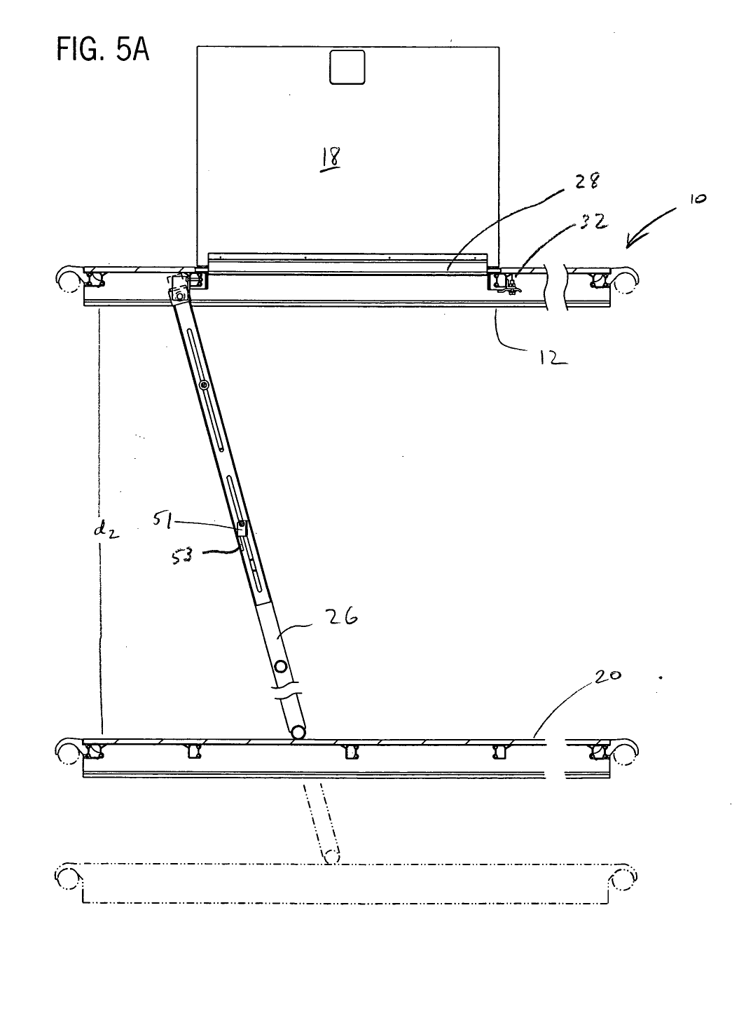

FIG. 5 is a side sectional view of the scaffold system 10 taken along line 5-5 of FIG. 1 showing the telescoping ladder 26 extended so that its length corresponds to a first distance d, between first and second deck structures 12 and 20, respectively. Similarly, FIG. 5a is a side cross-sectional view of the scaffold system 10 showing the telescoping ladder 26 extended so that its length corresponds to a second distance d₂ between the first and second deck structures. More specifically, the deck structures of the scaffold system can be designed to accommodate various heights as is appropriate to a specific job, and the ladder can be sized accordingly. The exact lengths and sizes of the ladder and deck structures can vary to convenience, as illustrated by the broken lines. Deck hatch 18 is shown in an open position in both FIGS. 5 and 5a, with the hatch having been rotatably opened using resilient scaffold hatch deck hinge 28.

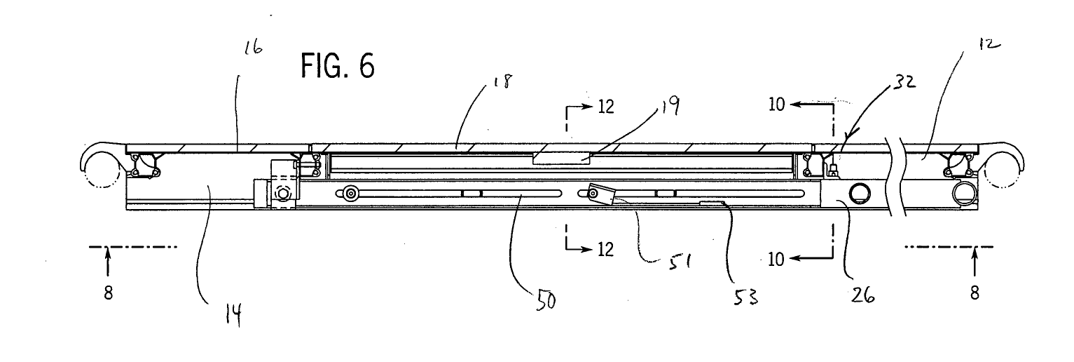

FIG. 6 is an enlarged, cross-sectional view of the deck structure 12 and telescoping ladder 26 taken along line 6-6 of FIG. 2. The ladder 26, along with slide member 27, is securably stowed away in its retracted position within the perimeter or space delineated by first deck structure frame 14, to which it is attached via mounting bracket 40. Also illustrated is slot 50 in the slide member 27. Ladder 26 slides via the slot, and in this manner can be extended when the ladder is to be “in use”. Also shown are deck 16 and deck hatch 18, which can be opened using handle 19.

Referring to FIGS. 5, 5a and 6, there are thus three primary positions of the telescoping ladder 26. Those positions can be described as follows. FIG. 6 illustrates the telescoping access ladder 26 in a retracted position where the ladder is secured, via the latch mechanism 32, for stowing and/or transport. Bracket 51, as shown, is positioned spaced apart from, so as not to contact, stop block 53. FIG. 5a shows the ladder 26 disengaged from the latch mechanism and swung or lowered downwardly into a partially extended position suitable for climbing, and corresponding to a distance d₂. As illustrated, bracket 51 is slid so as to contact stop block 53. Finally, FIG. 5 shows the ladder 26 having been fully extended to a distance d₂. Here, the bracket 51 has been moved to a position at the end of slot 50, and thus past stop block 53.

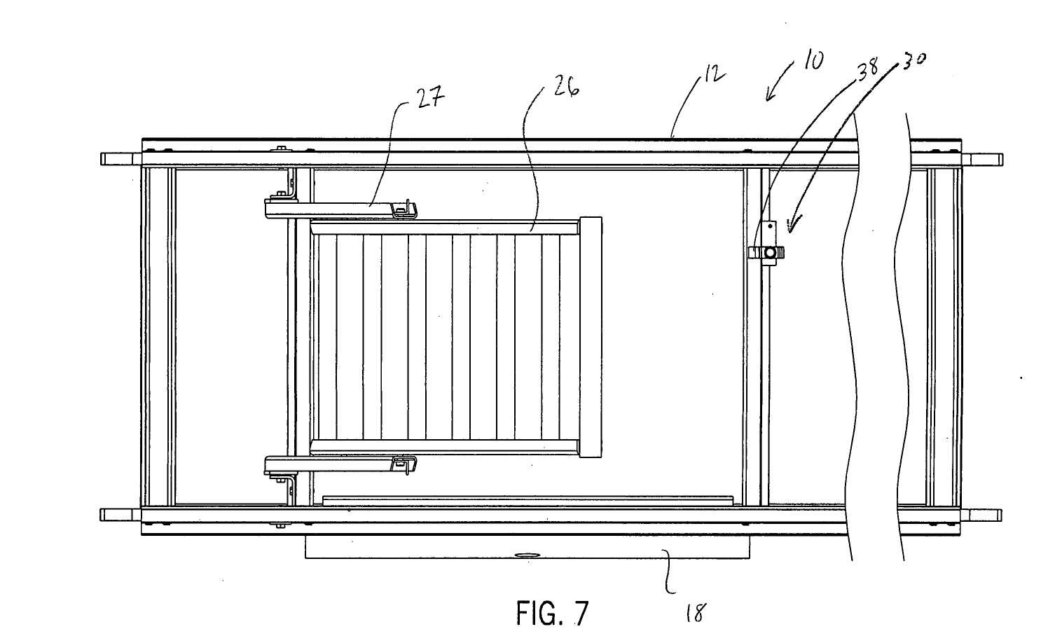

FIG. 7 is a top view of the first deck structure 12 of scaffold system 10 taken along line 7-7 of FIG. 5. FIG. 7 shows the telescoping ladder 26 extended so that a scaffold worker can move between deck structures. The deck hatch 18 is open. The ladder latching the device 30, and more specifically, the positive latch mechanism 38 has been rotated to disengage the device from the ladder, permitting the ladder to be extended to the desired distance (i.e., to a distance corresponding to the distance between the first deck structure and the next adjacent deck structure). Again, this is accomplished by sliding the ladder 26 with respect to the slide member 27. In use, the ladder can be adjusted to the height or distance between the scaffold deck sections as the user swings the ladder into place. In this manner, the set up or positioning of the ladder into the extended position is greatly facilitated as the present invention does not require the use of engagement pins to hold the ladder in place, as was required in the past.

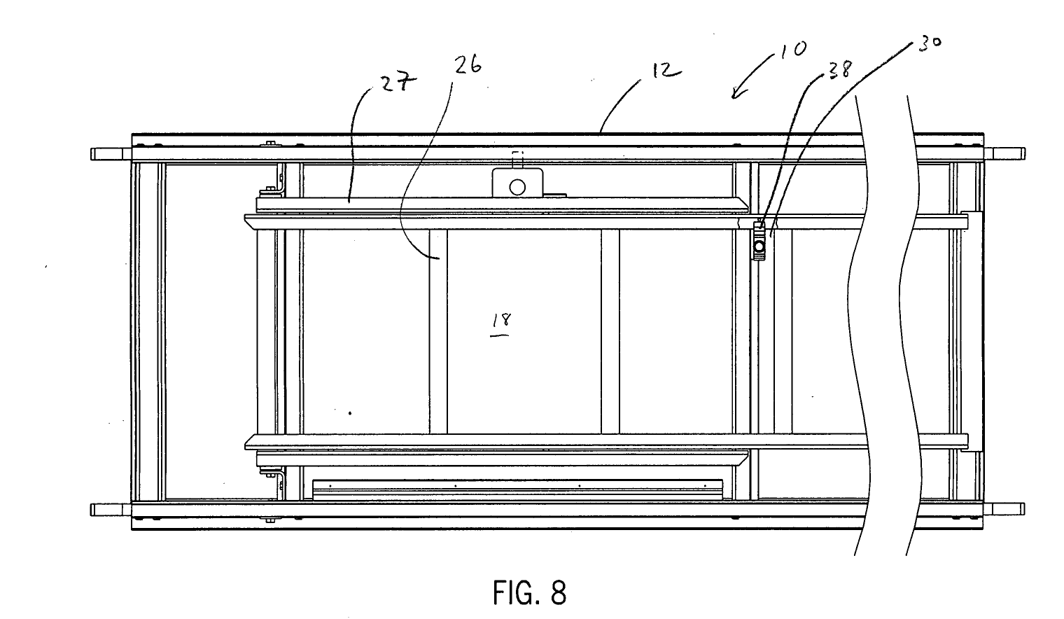

FIG. 8 is a bottom view of the first deck structure 12 of scaffold system 10 taken along line 8-8 of FIG. 6. FIG. 8 shows the telescoping ladder 26 retracted, which as noted above, is desirable when the deck structure is transported or stored. The deck hatch 18 is closed. The ladder latching the device 30, and more specifically, the positive latch mechanism 38 has been rotated to engage and secure the ladder 26,

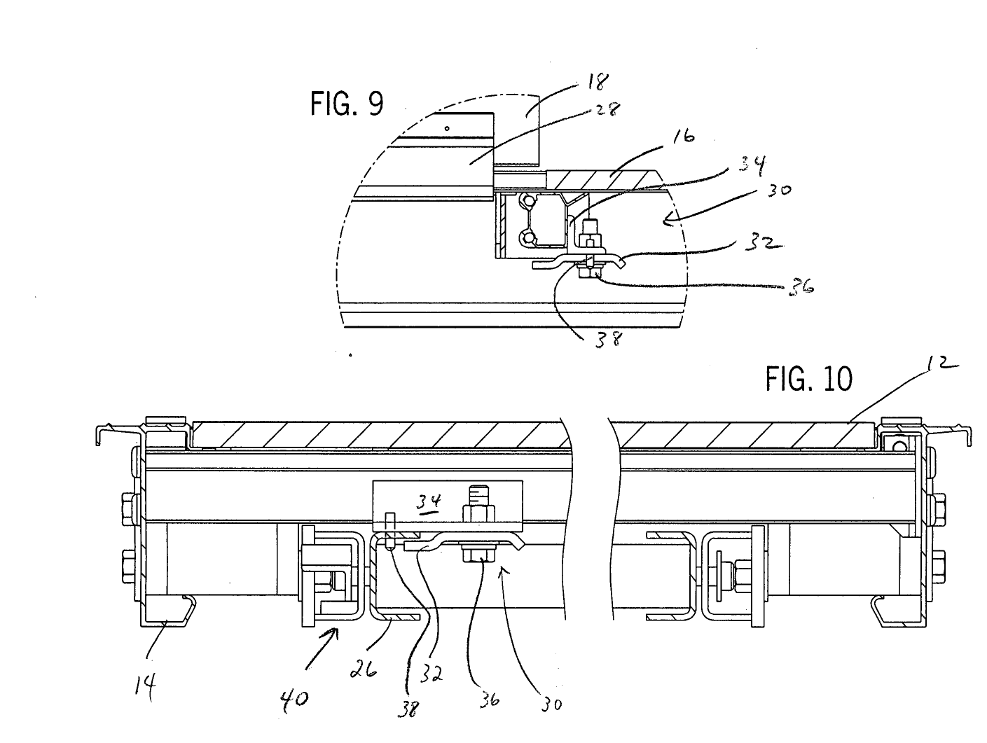

FIG. 9 is an enlarged view of the latching device 30 taken along line 9-9 of FIG. 5. The device 30 again includes a restraint mechanism 32 which is connected via extension section 34 to frame 14, and is rotatable about nut and bolt arrangement 36. The device 30 is disposed below deck 16. The deck hatch 18 has been opened about resilient hinge 28. Sliding mechanism 32 cooperates with latch mechanism 38 to secure (or release) the ladder 26. The ladder (not shown) is extended and thus the latching the device is in a disengaged or “open” position.

FIG. 10 is a side sectional view of the telescoping ladder 26 taken along line 10-10 of FIG. 6 with the ladder in a retracted position with respect to first deck structure 12. Here, the latching device 30 is in an engaged or “closed” position so as to secure the ladder 26 in its retracted position for storage and/or transport. More specifically, restraint mechanism 32, which is connected to extension section 36, has been rotated via nut and bolt arrangement 36 and cooperates with latch mechanism 38 to secure ladder 26 efficiently within a spaced defined by first deck structure frame 14. Ladder mounting assembly 40, described in detail above, is also visible.

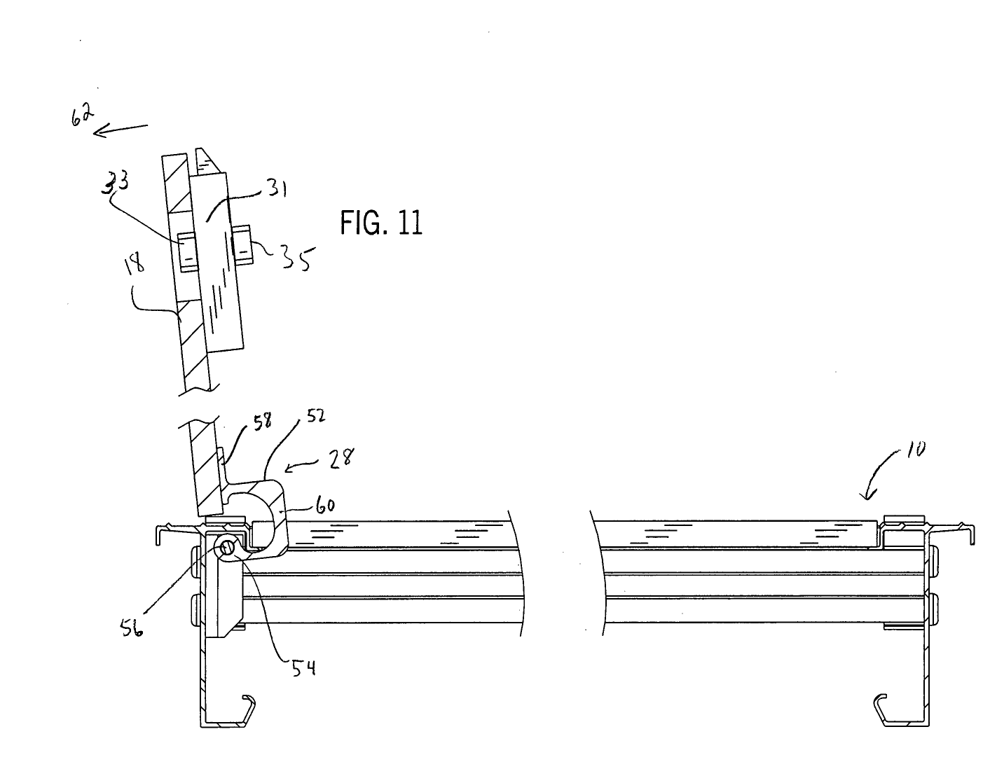

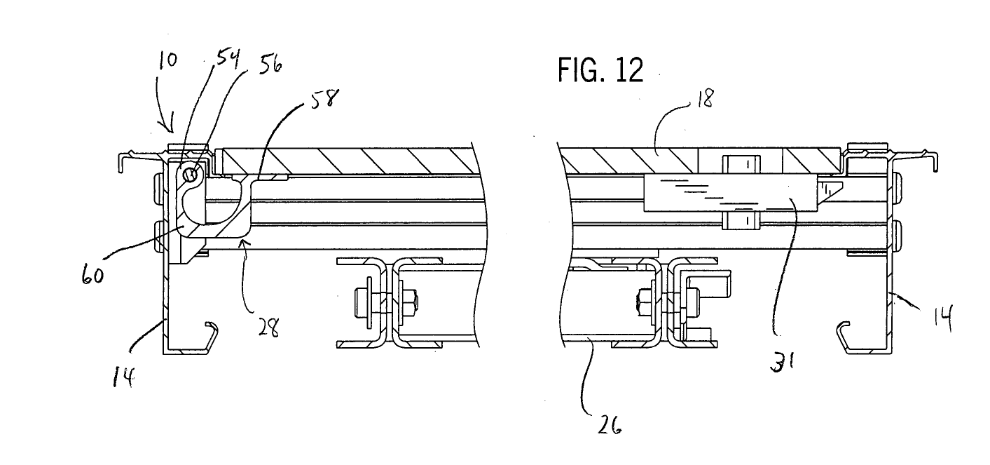

FIG. 11 is a cross-sectional view taken along line 11-11 of FIG. 5, illustrating the deck hatch 18 secured via resilient hatch deck hinge 28 to the deck structure 12. The deck hatch 18 is shown in an open position. FIG. 12 is a cross-sectional view taken along line 12-12 of FIG. 6 showing the deck hatch, secured 18 secured via resilient hatch deck hinge 28 to the deck structure 12. The deck hatch is shown in a closed position. In FIG. 12, the telescoping ladder 26 is shown in its retracted position such that it is located within the boundary set out by frame 14.

Referring to FIGS. 11-12, the resilient scaffold hatch deck hinge 28 comprises a hinge body 52. The hinge body 52 includes a hinged connection portion 54 for rotatable connection to a scaffolding structure 10, as shown, via rod 56. The hinge body further includes a substantially planar deck hatch-connecting portion 58 for fixed connection to scaffolding hatch deck 18. The hinge body further includes a contoured bridging portion 60 connecting hinged connection portion 54 to the deck-connecting portion 58. Advantageously, the hinge body, and in particular the hinged connection portion, the deck hatch-connecting portion and the contoured bridging portion, functions to prevent over-rotating of the hinge body past a limit position beyond which at least one of the deck hatch, the hinge, and the frame can be deformed or damaged. Handle 31 is used to facilitate opening and closing of the hatch, as well as securing the hatch in the closed position. The door can be locked using, for example, a spring-loaded deadbolt, and in the embodiment shown, the door can be opened or closed from above or below by knobs 33 and 35. In a preferred embodiment, the resilient scaffold hatch deck hinge 28 extends substantially the entire length of a hatch to which it can be connected.

Significantly, the resilient scaffold hatch deck hinge is designed to accommodate and distribute significant stresses that are imparted on it when it is in use (i.e., when the deck hatch with is secured to the scaffold structure is open or closed by a scaffold user, the wind, etc.). Stress analysis has been conducted to achieve the design depicted in and the analysis has shown the following: Significantly, the present inventive hinge design permits the hinge to withstand a force (e.g., about 40 lbs. or even more) applied in a direction, indicated by arrow 62, that is perpendicular to the fully opened hatch deck 18, sufficient to overturn an unsecured hatch deck.

In a preferred embodiment, the hatch deck hinge is constructed from aluminum, resulting in a strong, light hinge that is very resistant to over rotating when the hatch is opened. Advantageously, the inventive hinge is less susceptible to distortion during normal operation when compared to previous solutions (which typically might have been made of a low-grade steel material).

In this application, a scaffold system, structure, subassemblies and mechanisms have been described and shown. More specifically, a telescoping ladder, a ladder latch, a deck hinge and a scaffolding structure are described in detail and shown in the Figures. The telescoping ladder permits varying of ladder height in a scaffolding environment. The telescoping ladder is beneficial when a scaffold system is used in jobs of varying size and scope. The ladder latch provides secure, user-friendly, and durable means for securing the ladder to the scaffolding structure. The scaffolding hatch deck hinge provides a durable means for securing a deck hatch to a deck while minimizing over shape-distortion to the hinge during, for example, over-rotating of the deck hatch by a user. The scaffold structure provides a landing area that promotes usability of the scaffolding in environments in which buildings have non-linear, angled, or contoured profiles.

Scaffold systems have different installed heights (or distances between scaffold deck sections) depending on the project at hand. As a result, each scaffolding system typically requires its own type of access ladder (i.e., a ladder of a given length). The aforementioned telescoping access ladder, with its associated sliding mechanism and design, provides a solution that permits the ladder to be used with and accommodate scaffold systems of different installed heights. The sliding latch mechanism that secures the ladder in its retracted position is advantageously accessible from above the ladder/deck by a scaffold worker when the deck hatch is open, and as such, there is no need to cut a hole through the deck to accomplish releasing of the ladder from its retracted position to its extended position.

Hatch decks are advantageous in that a user can ascend a scaffold system from one deck structure to the next while remaining inside the scaffold footprint. This reduces the potential height of a fall to the distance between 2 consecutive deck structures (as opposed to the distance from a given position of the worker to the ground). Hatch decks reduce, or potentially eliminate the need to have any access ladder(s) outside of the scaffold footprint or scaffold structure.

In general, while the present invention has been described in terms of preferred embodiments, it is recognized that equivalents, alternatives, and modifications, aside from those expressly stated, are possible and within the scope of the appending claims.

1. A scaffold system comprising:
a first deck structure having first deck structure frame, a deck connected to the frame and including a deck hatch;
a second deck structure having a second deck structure frame and a deck connected to the frame, the second deck structure positioned at a distance from, and connectable to, the first deck structure;
a telescoping ladder positioned between the first and second deck structures and connectable to at least one of the first and the second deck structures, the telescoping ladder extendable to a length that corresponds to the distance between the first and the second deck structures.

2. The scaffold system of claim 1 further comprising a resilient scaffold hatch deck hinge, the hinge connected to the first deck structure frame and to the deck hatch, to permit the hatch deck to rotate between an open position and a closed position.

3. The scaffold system of claim 1 further comprising a ladder latch for fixedly securing the telescoping ladder to the deck structure when the telescoping ladder is in a retracted position.

4. The scaffold system of claim 1, further comprising:
a resilient scaffold hatch deck hinge comprising:
a hinge body, the body having:
a rod-receiving portion for rotatable connection to a scaffolding structure;
a substantially planar deck-connecting portion for substantially rigid connection to a scaffolding hatch deck; and
a contoured bridging portion for connecting the rod-receiving portion to the substantially planar deck-connecting portion.

5. The scaffold system of claim 4 wherein the hinge body extends substantially an entire length of a hatch to which it can be connected.

6. The scaffold system of claim 5 wherein one of the rod-receiving portions, the substantially planar deck-connecting portions, and the contoured bridging portions function to prevent over-rotating of the hinge body past a limit position.

7. The scaffold system of claim 1 further comprising a slide member connected to the first deck structure frame and slideably engageable with the telescoping ladder to permit the ladder to slide between a retracted position for at least one of transport and storage and an extended position for access and climbing by a scaffold worker.

8. The scaffold system of claim 7 wherein the slide member includes a slot to engage the ladder in a sliding fashion.

9. The scaffold system of claim 1 further comprising a ladder mounting assembly having a ladder mount and pivot bracket which is secured to deck frame and a slide mechanism, and wherein the slide mechanism is slideably connected to the telescoping ladder.

10. The scaffold system of claim 9, wherein the ladder mounting assembly permits the ladder to be retracted for at least one of stowing and transport, and extended to attain a desired length that corresponds to the distance between deck structures.

11. The scaffold system of claim 1 wherein the telescoping ladder can be positioned in retracted, partially extended, and fully extended positions.
